(19) United States
(12) Patent Application Publication
(10) Pub. No.: US 2016/0223160 A1
(43) Pub. Date: Aug. 4, 2016

(54) REFLECTING STRUCTURE OF PROJECTING LAMP

(71) Applicant: Taiwan Network Computer & Electronic Co., Ltd., New Taipei City (TW)

(72) Inventors: Chia-Mei PENG, Ping-Chen City (TW); Hsieh-Chen CHUANG, New Taipei City (TW); Ping-Han CHUANG, New Taipei City (TW)

(21) Appl. No.: 14/608,935

(22) Filed: Jan. 29, 2015

(51) Int. Cl. F21V 7/10; F21V 7/00; F21V 7/05

(52) U.S. Cl. CPC F21V 7/10; F21V 7/05; F21V 7/0025

(57) ABSTRACT

A reflecting structure of the invention includes at least one light source emitting light; and at least one reflector having an inner surface comprising a plurality of strip reflecting surfaces connected to each other, and each of the strip reflecting surfaces having an inclined angle different from the inclined angles of other strip reflecting surfaces, wherein the reflector has an inward reflecting region and an outward reflecting region, wherein the light source is disposed in the inward reflecting region, and the inward reflecting region locates on an upper portion of the reflector and the outward reflecting surface locates on an lower portion of the reflector; light from the light source is reflected by the inward reflecting region at least once to reach the outward reflecting region and reflected by the outward reflecting region at least once to reach an object.

### BACKGROUND OF THE INVENTION

1. Field of the Invention

The invention relates to a reflecting structure of a projecting lamp, and more particularly to a reflecting structure of a projecting lamp for illuminating a banner or ceiling, which reflects light of a light source to a predetermined illuminating region.

2. Description of the Related Art

A conventional lamp includes a reflector disposed around a light source. Reflectors of different type form illuminating regions of different shapes.

Referring to FIG. 1A, a conventional lamp for illuminating a banner includes a curved reflector 102. The reflector 102 has an inner surface which is a reflecting surface 103. A lamp tube 104 is disposed in an inner space of the reflector 102. When the lamp is disposed in a predetermined position under a banner 101 having a height of 6 meter. Light emitting directly from the light source illuminates a region 105 of the banner, whereas other light emitting directly from the light source travels to the sky shown by a region 106 or to the ground shown by a region 107. Referring to FIG. 1B, a part of light emitting from the light source and reflected by the reflecting surface 103 also travels to the sky shown by a region 109, and although most of the reflected light 108 reaches the banner 101, however a large portion of light 110 concentrates on a lower half of the banner 101. Since such a conventional lamp uses a C-shaped reflector having a low lighting efficiency and a small lighting angle field, the banner illuminated by the conventional lamp has a larger illuminance in the lower half portion than in the upper half portion.

### BRIEF SUMMARY OF THE INVENTION

An object of the invention is to provide a reflecting structure of a projecting lamp enabling most light to reach a specific region, whereby lighting efficiency is raised.

Another object of the invention is to provide a reflecting structure of a projecting lamp enabling a length and a width of an illuminating region to become adjustable.

Another object of the invention is to provide a reflecting structure of a projecting lamp enabling a specific illuminating region to have a uniform brightness.

The invention provides a reflecting structure for a projecting lamp. The reflecting structure in accordance with an exemplary embodiment of the invention includes at least one light source emitting light; and at least one reflector having an inner surface comprising a plurality of strip reflecting surfaces connected to each other, and each of the strip reflecting surfaces having an inclined angle different from the inclined angles of other strip reflecting surfaces, wherein the reflector has an inward reflecting region and an outward reflecting region, wherein the light source is disposed in the inward reflecting region, and the inward reflecting region locates on an upper portion of the reflector and the outward reflecting surface locates on an lower portion of the reflector; light from the light source is reflected by the inward reflecting region at least once to reach the outward reflecting region and reflected by the outward reflecting region at least once to reach an object.

In another exemplary embodiment, a distance from each of the strip reflecting surfaces to the light source increases gradually from the strip reflecting surface on a bottom of the reflector to the strip reflecting surface on a top of the reflector.

In yet another exemplary embodiment, the reflector comprises a plurality of members, and each of the members has a plurality of strip reflecting surfaces connected to each other, and each of the strip reflecting surfaces having an inclined angle different from the inclined angles of other strip reflecting surfaces.

In another exemplary embodiment, the reflector comprises a wide strip reflecting surface disposed between the outward reflecting region and the inward reflecting region, at least one light emitting diode is disposed on the wide strip reflecting surface, and a plurality of fins is disposed on an outer surface of the reflector.

In yet another exemplary embodiment, the reflector further comprises a clamp disposed in an inner space of the reflector.

In another exemplary embodiment, the reflector further comprises a second reflecting region comprising at least one strip reflecting surface extending outwards from a bottom of the reflector.

In yet another exemplary embodiment, the reflector comprising the strip reflecting surfaces connect to each other has a J-shaped cross section.

In another exemplary embodiment, the reflector comprising the strip reflecting surfaces connect to each other has a G-shaped cross section.

In yet another exemplary embodiment, the reflector further comprises a plurality of positioning structures protruding from the inner surface.

In another exemplary embodiment, the reflector further includes two end surface, and at least one positioning structure is disposed on each of the end surfaces respectively.

In yet another exemplary embodiment, the reflector has a top each of the strip reflecting surfaces has a length, and the length decreases gradually from the strip reflecting surface on a top of the reflector to the strip reflecting surface on a bottom of the reflector.

In another exemplary embodiment, the reflector includes a plurality of members, and each of the members has a plurality of strip reflecting surfaces connected to each other, and each of the strip reflecting surfaces having an inclined angle different from the inclined angles of other strip reflecting surfaces.

In yet another exemplary embodiment, the reflecting structure further includes a second reflector disposed on a bottom of the reflector, wherein the second reflector comprises a bottom reflecting surface and two lateral convex reflecting surfaces connected to the bottom reflecting surface to form a U shape; the bottom reflecting surface is a planar surface, and each of the lateral convex reflecting surfaces comprises a plurality of curved surfaces connected to each other, and each of the curved surfaces has an inclined angle and a curvature different from the inclined angles and the curvatures of other curved surface.

In another exemplary embodiment, each of the lateral convex reflecting surfaces has a front end and a notch formed on the front end.

In yet another exemplary embodiment, the second reflector includes a plurality of members.

In another exemplary embodiment, the reflecting structure further includes a second reflector disposed on a bottom of the reflector, wherein the second reflector comprises a bottom reflecting surface and two lateral convex reflecting surfaces connected to the bottom reflecting surface to form a U shape; the bottom reflecting surface comprises a central curved reflecting surface and a planar surface enclosing the central curved reflecting surface, and each of the lateral convex reflecting surfaces includes a plurality of curved surfaces connected to each other, and each of the curved surfaces has an inclined angle and a curvature different from the inclined angles and the curvatures of other curved surface.

In yet another exemplary embodiment, each of the lateral convex reflecting surfaces has a front end and a notch formed on the front end.

In another exemplary embodiment, the second reflector comprises a plurality of members.

A reflecting structure in accordance with another exemplary embodiment of the invention includes at least one light source emitting light; and at least one reflector having an inner surface comprising a plurality of members to form a J-shaped cross section, wherein each of the member comprises a plurality of curved reflecting surfaces connected to each other, each of the curved reflecting surfaces has an inclined angle different from the inclined angles of other curved reflecting surfaces, and a distance from each of the curved reflecting surfaces to the light source increases gradually from the curved reflecting surface on a bottom of the reflector to the curved reflecting surface on a top of the reflector; the reflector has an inward reflecting region and an outward reflecting region, wherein the light source is disposed in the inward reflecting region, and the inward reflecting region locates on an upper portion of the reflector and the outward reflecting surface locates on an lower portion of the reflector; light from the light source is reflected by the inward reflecting region at least once to reach the outward reflecting region and reflected by the outward reflecting region at least once to reach an object.

In yet another exemplary embodiment, the reflector further includes a clamp disposed in an inner space of the reflector.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B depict a conventional reflecting structure; and

FIGS. 2A and 2B depict the first embodiment of a reflecting structure of the invention;

FIGS. 3A and 3B depict light reflection of the reflecting structure of the first embodiment of the invention;

FIGS. 4A and 4B depict a reflecting structure of the invention used in a lamp;

FIG. 5A is a schematic view of the second embodiment of a reflecting structure of the invention;

FIG. 5B is a schematic view of the third embodiment of a reflecting structure of the invention;

FIGS. 6A and 6B depict the fourth embodiment of a reflecting structure of the invention;

FIG. 7 is a schematic view of the fifth embodiment of a reflecting structure of the invention;

FIG. 8A is a schematic view of the sixth embodiment of a reflecting structure of the invention;

FIG. 8B is a schematic view of the seventh embodiment of a reflecting structure of the invention;

FIGS. 9A and 9B depict a reflecting structure of the invention used in a lamp;

FIGS. 10 A and 10B depict the eighth embodiment of a reflecting structure of the invention;

FIG. 11 depicts a reflecting structure of the invention used in a lamp;

FIGS. 12 A and 12B depict the first embodiment of a second reflector of the invention;

FIGS. 13A and 13B depict the second embodiment of a second reflector of the invention;

FIGS. 14 A to 14C depict the third to the fifth embodiments of a second reflector of the invention;

FIGS. 15 A and 15B depict the ninth embodiment of a reflecting structure of the invention; and

FIGS. 16 A and 16B depict the tenth and eleventh embodiments of a reflecting structure of the invention.

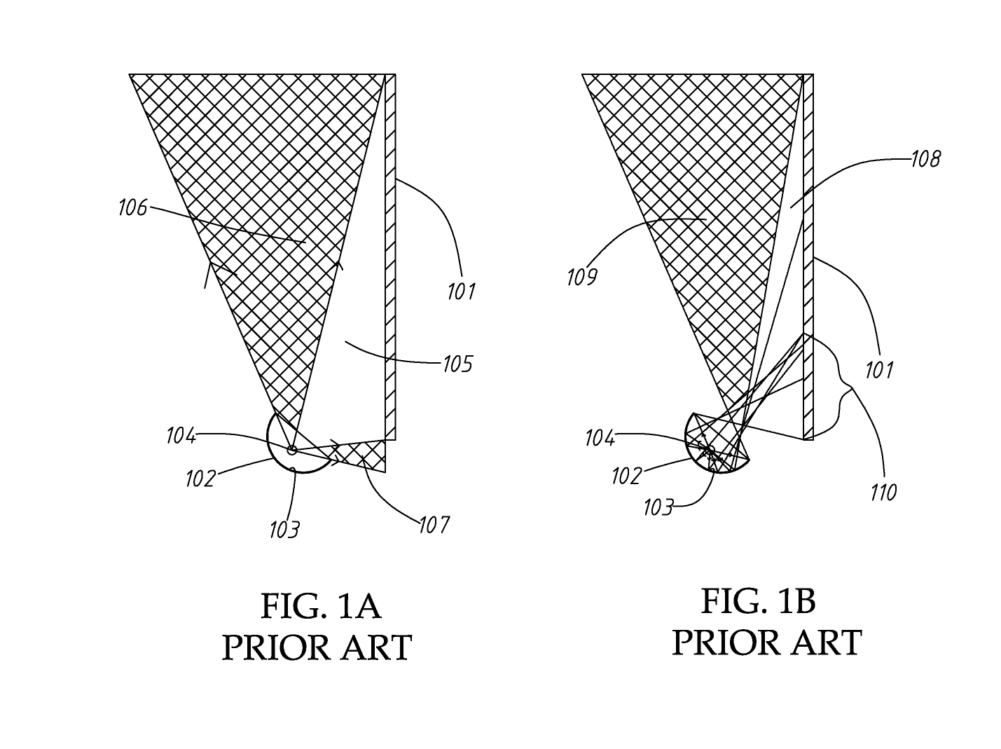

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

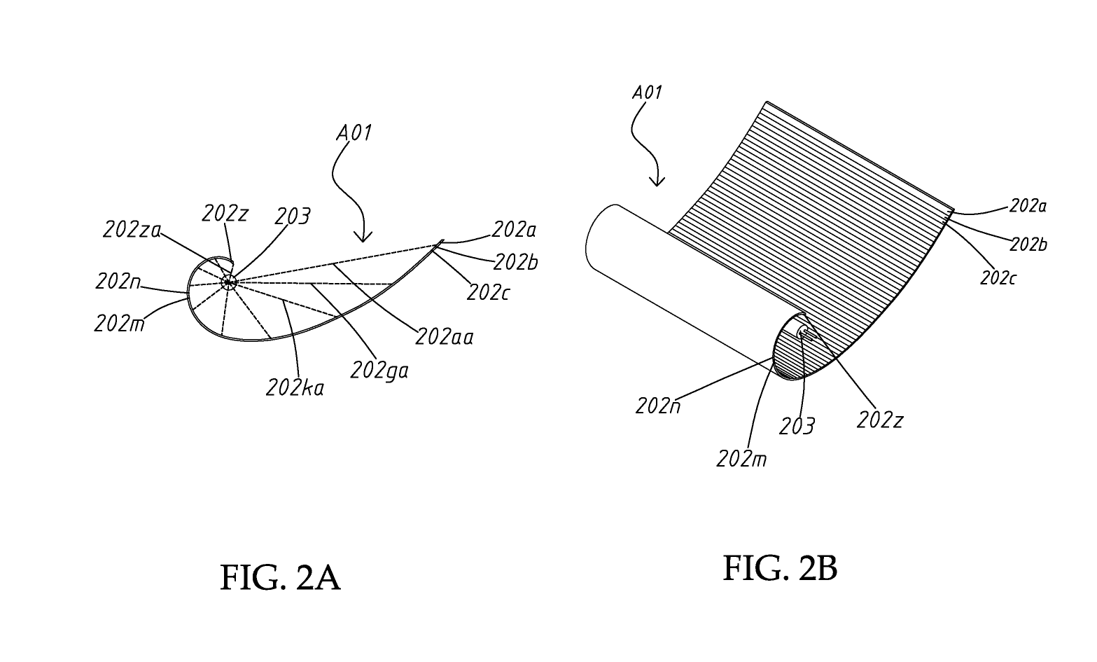

Referring to FIGS. 2A and 2B, a reflecting structure of the invention includes a reflector A01 having an inner surface which is a reflecting surface. The reflecting surface includes a plurality of strip reflecting surfaces 202 a, 202b, 202c to 202z connected to each other to form a reflector having a J-shaped cross section which has a small curvature. Each of the strip reflecting surfaces has an inclined angle different from the inclined angles of other strip reflecting surfaces. The reflector A01 has an outward reflecting region formed on an upper half portion of the reflector A01 and including the strip reflecting surfaces from the strip reflecting surface 202a on a top of the reflector A01 to the strip reflecting surface 202m. The reflector A01 further has an inward reflecting surface formed on a lower half portion of the reflector A01 and including the strip reflecting surfaces from the strip reflecting surface 202n to the strip reflecting surface 202z on a bottom of the reflector A01. A light source 203 is disposed in a position near the strip reflecting surface 202z in the inward reflecting region. The distance between the strip reflecting surfaces to the center of the light source 203 gradually increases from the bottom to the top of the reflector A01. The dashed line 202aa representing the distance from the strip reflecting surface on the top of the reflector A01 to the light source 203 is the longest, and the dashed lines 202ga, 202ka are shorter than the dashed line 202aa. The dashed line 202za representing the distance from the strip reflecting surface on the bottom of the reflector A01 to the light source 203 is the shortest. Therefore, the reflector A01 formed by the strip reflecting surfaces has a spiral cross section. In this embodiment, the strip reflecting surfaces have an identical length, and the reflector is suitable for tubular light source, such as a fluorescent lamp or LED lamp.

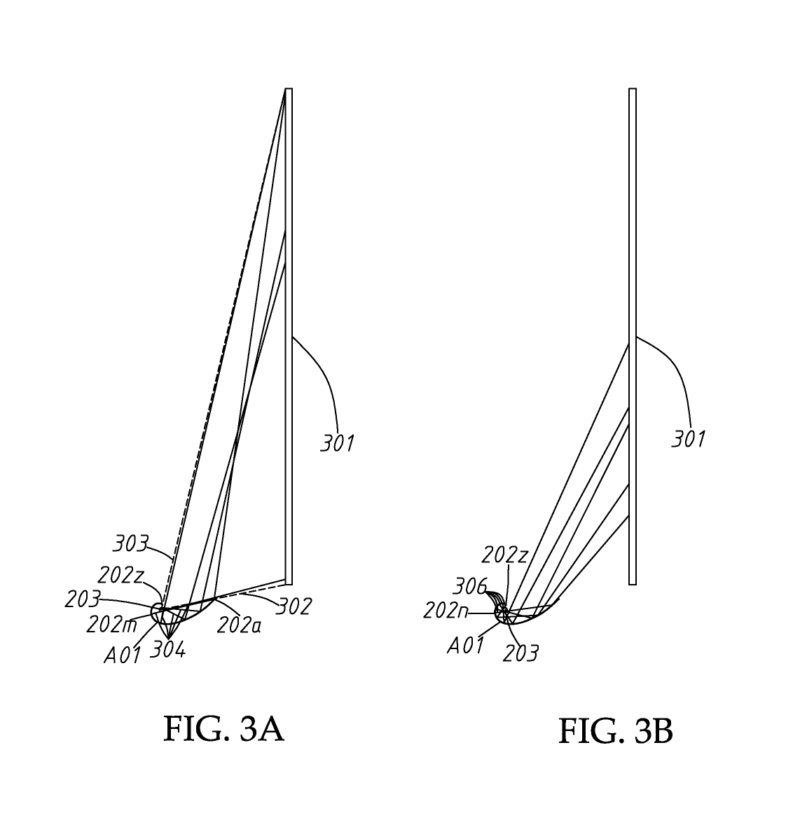

Referring to FIGS. 3A and 3B, the reflector A01 of the invention reflects light to illuminate a banner. As shown in FIG. 3A, the light source 203 is disposed in the inward reflecting region on the lower half portion of the reflector A01. The strip reflecting surface 202z determines the maximal projecting angle at which light is directly projected to a top of the banner 301, and the strip reflecting surface 202a determines the minimal projecting angle at which the light is directly projected to a bottom of the banner 301. The reflector A01 limits a range of the light from the light source 203 to directly illuminate the banner. In addition to the light directly illuminate the banner, other light 304 from the light source 203 is reflected by the strip reflecting surfaces 202a to 202m in the outward reflecting region to reach a predetermined position on the banner. Referring to FIG. 3B, some other light 306 is reflected by the strip reflecting surfaces 202n to 202z in the inward reflecting region to reach the outward reflecting region, and reflected by the strip reflecting surfaces in the outward reflecting surfaces again to reach the banner. As shown in FIGS. 3A and 3B, all of light from the light source 203 reaches the banner 301 completely. Through adjusting reflection angle of each strip reflecting surface, illuminance of each projection region of the banner is regulated so as to obtain a uniform illuminance of the banner.

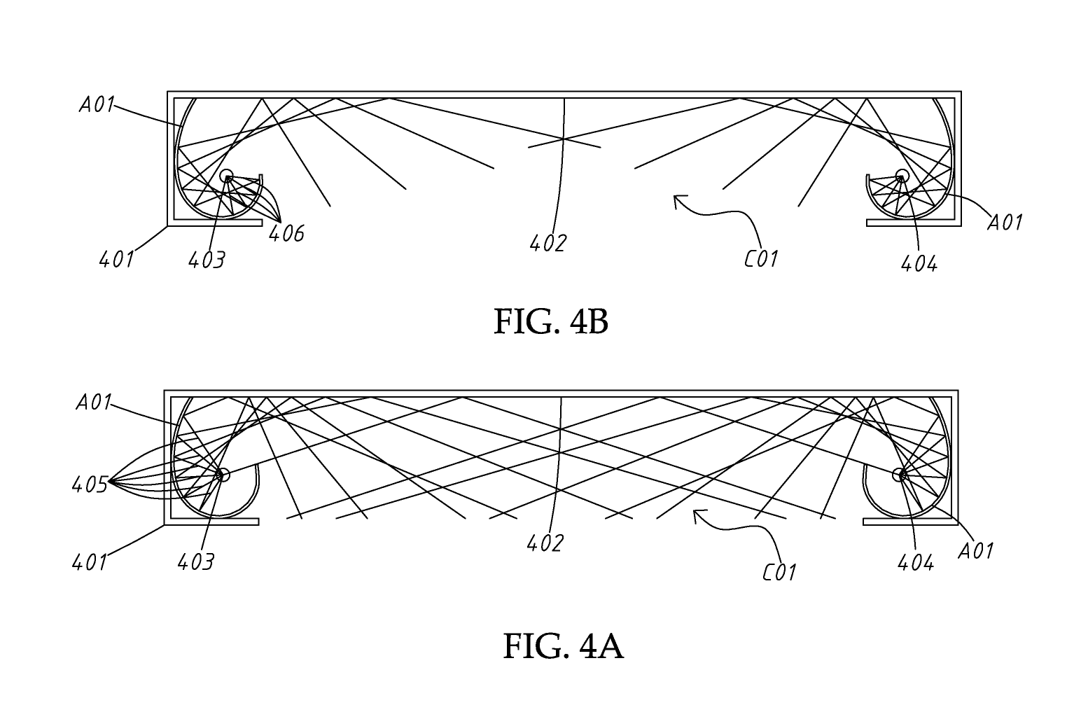

Referring to FIGS. 4A and 4B, a reflecting structure of the invention suitable for ceiling lamps. A lamp C01 has an anti-dust cover 401. The anti-dust cover 401 includes a reflecting surface 402 disposed on an inner side of a top of the anti-dust cover 401 and at least two reflector A01 disposed on an inner side of two lateral sides of the anti-dust cover 401. The reflector A01 has an inward reflecting region on a lower half portion and an outward reflecting region on an upper half portion. Light sources 403 and 404 are disposed in the inward reflecting region of the reflectors A01. The outward region includes a plurality of strip reflecting surfaces reflecting light 405 from the light sources 403 and 404. The reflected light reaches the reflecting surface 402 and reflected by the reflecting surface 402 to illuminate a predetermined region below the lamp C01. Light from the light sources 403 and 404 emitting the inward reflecting region is reflected by the reflector A01 twice to reach the predetermined region below the lamp C01. All light from the light sources 403 and 404 is reflected to reach the predetermined region below the lamp C01.

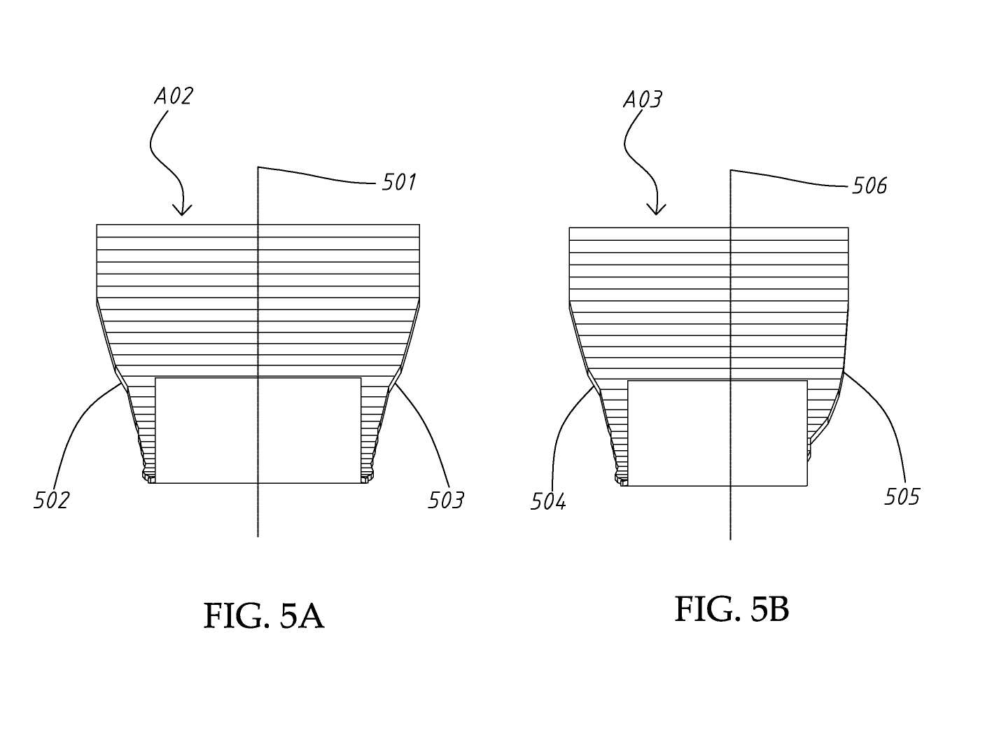

FIGS. 5A and 5B depict the second the third embodiments of a reflecting structure of the invention. The reflector A02 has a structure similar to the reflector A01 of FIG. 2. However, the length of the strip reflecting surfaces gradually decreases from the upper half region to the lower half region. The strip reflecting regions 502 and 503 formed on two lateral side of the reflector A02 are symmetrical so that each of the strip reflecting surfaces of the reflector A02 is symmetrical with a central line 501 (a perpendicular line extending through a center point of the light source), and each strip reflecting surface is divided into two portions having the same length by the central line 501. The reflector A03 shown in FIG. 5B has a structure similar to the reflector A01 shown in FIG. 2. However, the length of the strip reflecting surfaces gradually decreases from the upper half region to the lower half region. The strip reflecting regions 504 and 505 formed on two lateral side of the reflector A02 are non-symmetrical so that each of the strip reflecting surfaces of the reflector A02 is non-symmetrical with a central line 506 (a perpendicular line extending through a center point of the light source), and each strip reflecting surface is divided into two portions having a different length by the central line 506. The reflectors A02 and A03 are suitable for light source of short tube type, such as high-density discharge lamp or single high-power light emitting diode for illuminating regions of different width. The reflector A02 reflects light to illuminate a symmetrical region, whereas the reflector A03 reflects light to illuminate a non-symmetrical region.

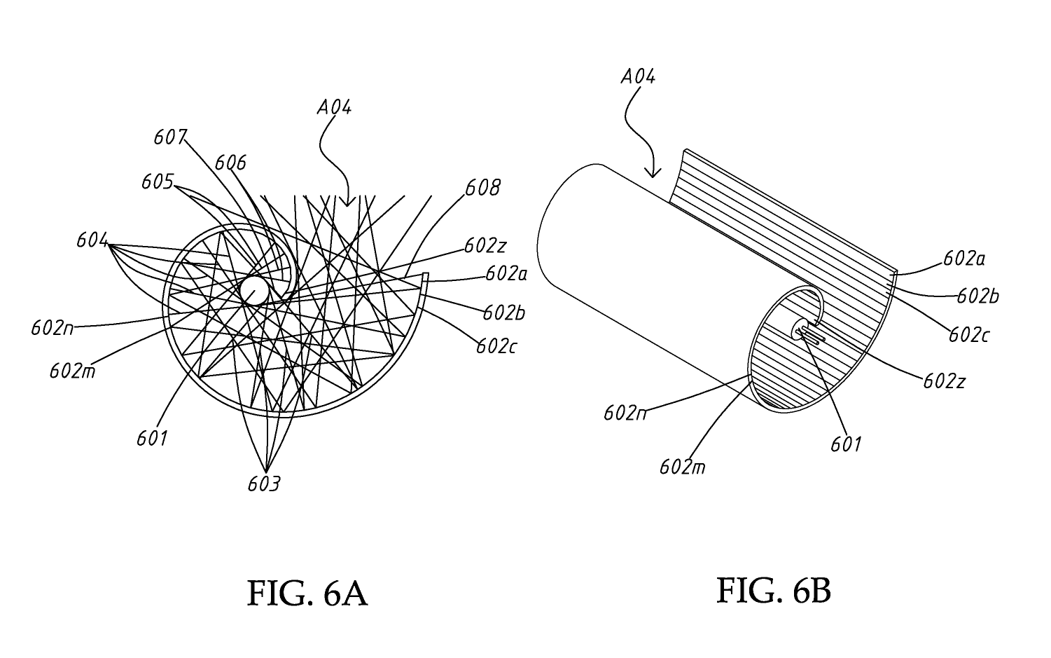

FIGS. 6A and 6B depict the fourth embodiment of a reflecting structure of the invention. The reflecting structure includes a reflector A04. The reflecting surface includes a plurality of strip reflecting surfaces 602 a, 602b, 602c to 602z connected to each other to form a reflector having a G-shaped cross section which has a small curvature. Each of the strip reflecting surfaces has an inclined angle different from the inclined angles of other strip reflecting surfaces. The reflector A04 has an outward reflecting region formed on an upper half portion of the reflector A04 and including the strip reflecting surfaces from the strip reflecting surface 602a on a top of the reflector A04 to the strip reflecting surface 602m. The reflector A04 further has an inward reflecting surface formed on a lower half portion of the reflector A04 and including the strip reflecting surfaces from the strip reflecting surface 602n to the strip reflecting surface 602z on a bottom of the reflector A04. A light source 601 is disposed in a position near the strip reflecting surface 602z in the inward reflecting region. The distance between the strip reflecting surfaces of the reflector A04 to the center of the light source 601 gradually increases from the bottom to the top of the reflector A04. A line 608 through an edge of the light source to an edge of the bottom of the reflector A04 extends to the strip reflecting surface 602a so that no light from a light source 601 reaches an illuminating region directly. In other words, all light from the light source 601 is reflected by the reflector A04 to the illuminating region. Light 603 emitting to the outward reflecting region is reflected once to the illuminating region. Light 604 emitting to the inward reflecting region is reflected to the outward reflecting region and reflected by the outward reflecting region again to the illuminating region. Light 605 emitting to the inward reflecting surface is reflected to the outward reflecting region and further reflected by the outward reflecting region twice to the illuminating region. Light 606 emitting to the inward reflecting region is reflected by the inward reflecting region twice to the outward reflecting region and reflected by the outward reflecting region to the illuminating region. Light 607 emitting to a position near a bottom of the inward reflecting region is reflected by the inward reflecting region twice and further reflected by the outward reflecting region twice to the illuminating region. Thus, even the light source 601 is enclosed by the spiral reflector A04, light from the light source 601 is reflected by the reflector A04 at most four times to reach the illuminating region. Light from a light source enclosed by a conventional C-shaped reflector or irregular shaped reflector is reflected dozens of times by the conventional C-shaped reflector or irregular shaped reflector to propagate out of the reflector and even most light cannot escape from the reflector, which reduces the illuminance of the illuminating region.

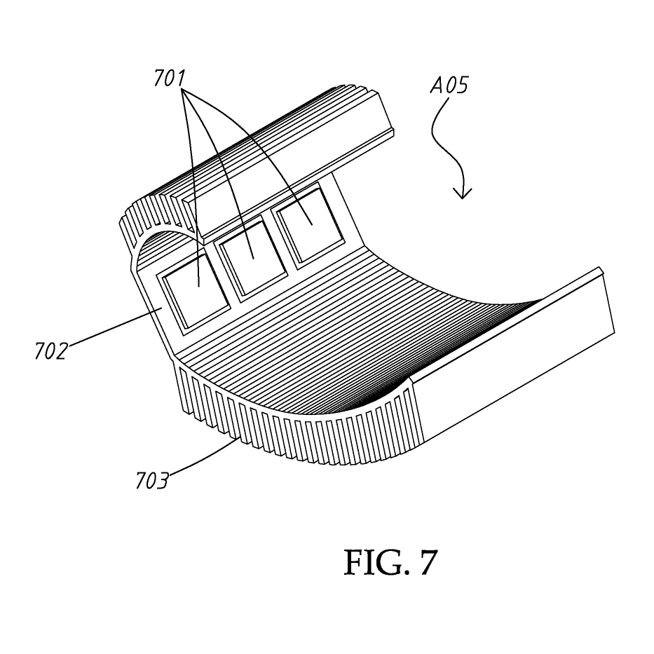

FIG. 7 depicts the fifth embodiment of a reflecting structure of the invention. The reflecting structure includes a reflector A05. The structure of the reflector A05 is similar to the reflector A01 of FIG. 2. The reflector A05 includes a wide strip reflecting surface 702 having a width larger than other strip reflecting surfaces. A light source 701 including at least one LED is disposed on the wide strip reflecting surface 702, and a plurality of fins are disposed on an outer surface of the reflector A05 for heat dissipation.

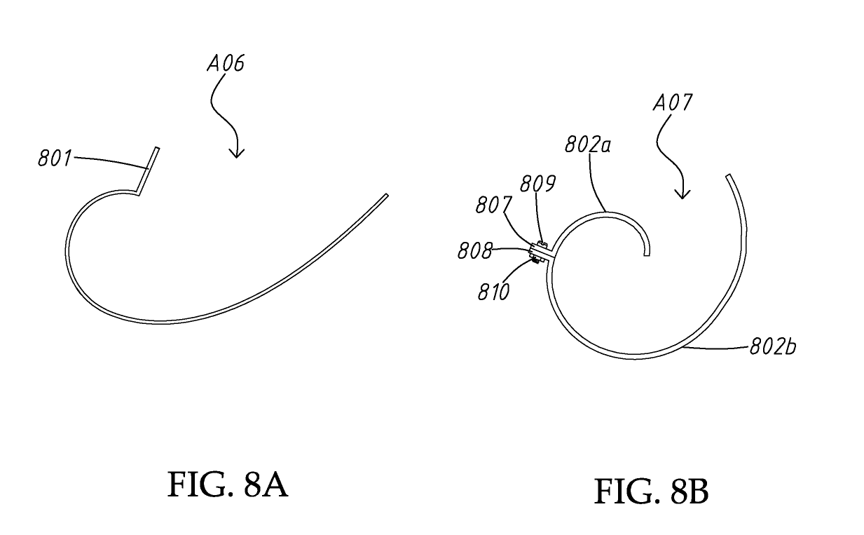

FIGS. 8A and 8B depict the sixth and seventh embodiments of a reflecting structure of the invention. Referring to FIG. 8A, the reflecting structure includes a reflector A06. The reflector A06 has a structure similar to the reflector A01 of FIG. 2. The reflector A06 further includes a strip reflecting surface 801 extends outwards from a bottom of the reflector A06. The strip reflecting surface 801 is a second reflecting region which reflects light direct from a light source or light reflected by the outward reflecting region on the upper half portion of the reflector A06 to an object. Referring to FIG. 8B, a reflector A07 includes at least two members joined to each other. Each of the described reflectors can be assembled by two members 802a and 802b. Each of the members has a plurality of strip reflecting surfaces connected to each other. Two positioning structures 807 and 808 are disposed on the members 802a and 802b respectively and protrude from the members 802a and 802b. The positioning structures 807 and 808 are joined together by a bolt 809 and a nut 810 or a spring which can be assembled or detached.

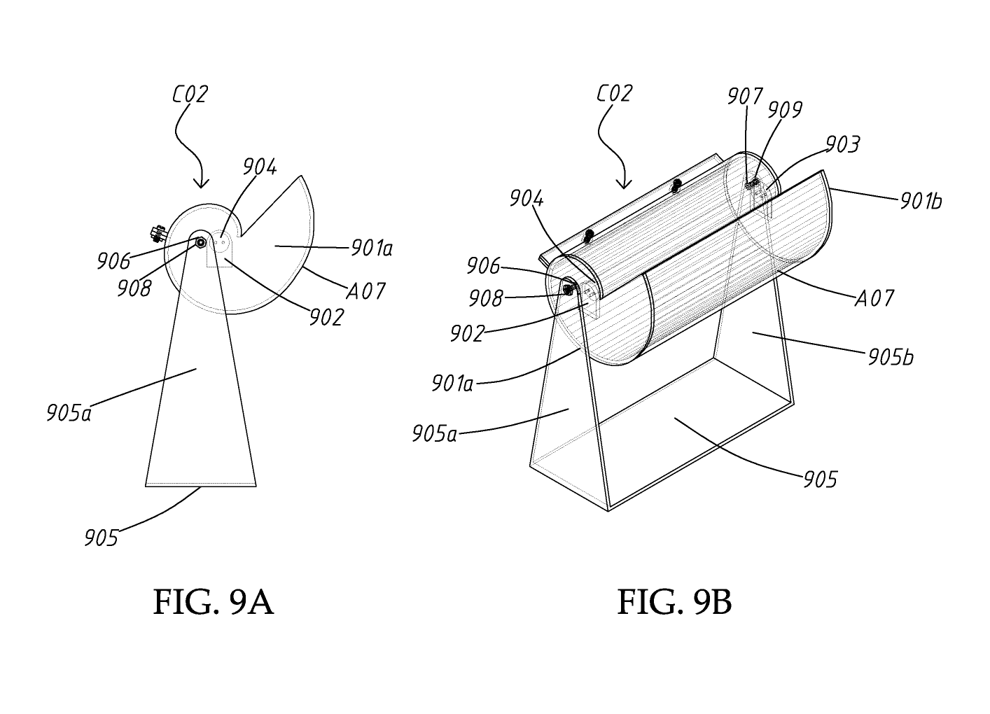

Referring to FIGS. 9A and 9B, a lamp C02 has a reflector A07 further includes two lateral plates 901a and 901b. Two light source sockets 902 and 903 are disposed on the lateral plates 901a and 901b. At least one light source 904 is mounted to the light source sockets 902 and 903. The lateral plates 901a and 901b are rotatably joined to two lateral sides 905a and 905b of a bracket 905 so that the reflecting A07 and the light source 904 become a structure capable of rotating 360° for regulating a projecting angle of the lamp C02. The reflector A07 further includes an anti-dust cover (not shown).

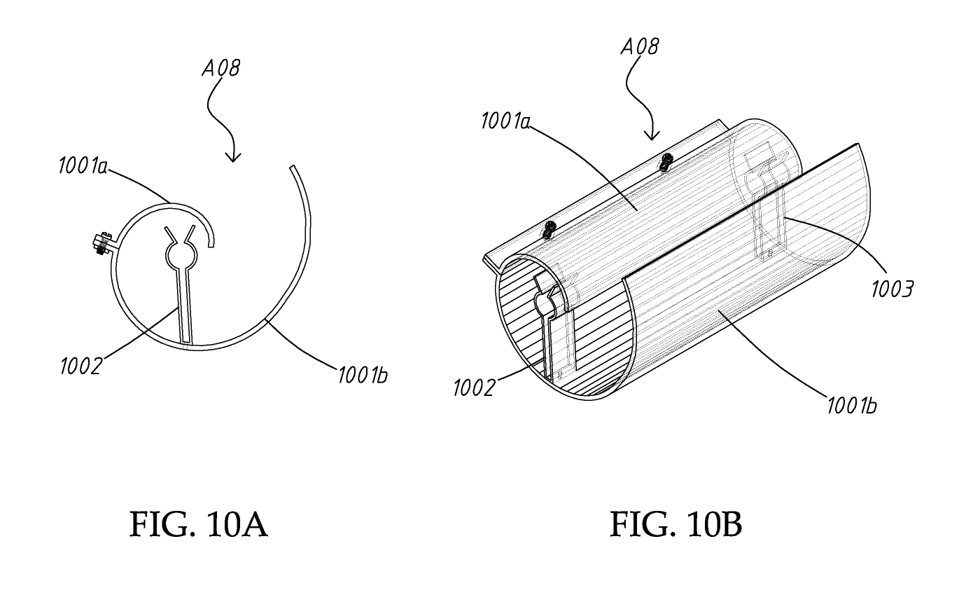

FIGS. 10A and 10B depict the eighth embodiment of a reflecting structure of the invention. The reflecting structure includes a reflector A08 including two members 1001a and 1001b. Two clamps 1002 and 1003 are disposed on the member 1001b, and a light source is held by the clamps 1002 and 1003, whereby the reflector A08 is capable of rotating 360°.

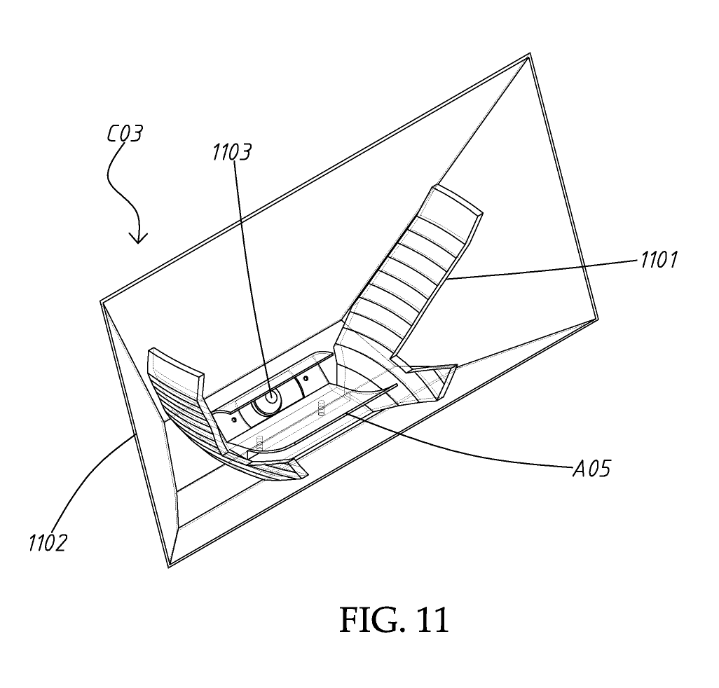

Referring to FIG. 11, a lamp C03 has an anti-dust cover 1102 and the reflector A05 of FIG. 7. A LED light source 1103 is disposed in the reflector A05. A second reflector 1101 disposed under the reflector A05. The second reflector 1101 reflects light from a light source which is not reflected by the reflector A05 to a predetermined region to increase the illuminance.

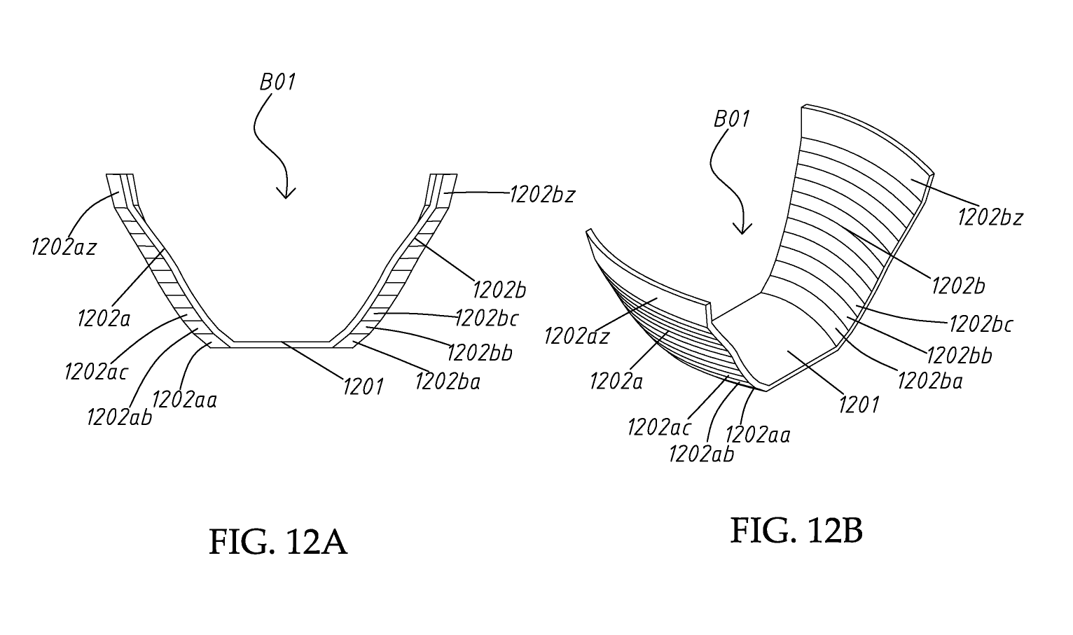

FIGS. 12A and 12B depict the first embodiment of a second reflector of the invention. A second reflector B01 includes an inner surface which is a reflecting surface. The second reflector B01 includes a bottom reflecting surface 1201 and two lateral convex reflecting surfaces 1202a and 1202b connected to the bottom reflecting surface 1201 to form a U shape. The reflector B01 can be integrally formed or assembled by at least two members. The bottom reflecting surface 1201 is a planar reflecting surface, and the lateral convex reflecting surface 1202a includes a plurality of curved surfaces 1202aa, 1202ab, 1202ac to 1202az. Each of the curved surfaces 1202aa, 1202ab, 1202ac to 1202az has an inclined angle and a curvature different from the inclined angle and the curvature of other curved surfaces. The lateral convex reflecting surface 1202b includes a plurality of curved surfaces 1202ba, 1202bb, 1202bc to 1202bz. Each of the curved surfaces 1202ba, 1202bb, 1202bc to 1202bz has an inclined angle and a curvature different from the inclined angle and the curvature of other curved surfaces. Although in this embodiment, the lateral convex reflecting surfaces 1202a and 1202b are symmetrical, however in other embodiments, the lateral convex surfaces can be non-symmetrical. Although in this embodiment each convex surface includes a plurality of inclined surfaces, however in other embodiments, each convex surface includes a plurality of curved surface or includes a plurality of inclined surfaces and curved surfaces.

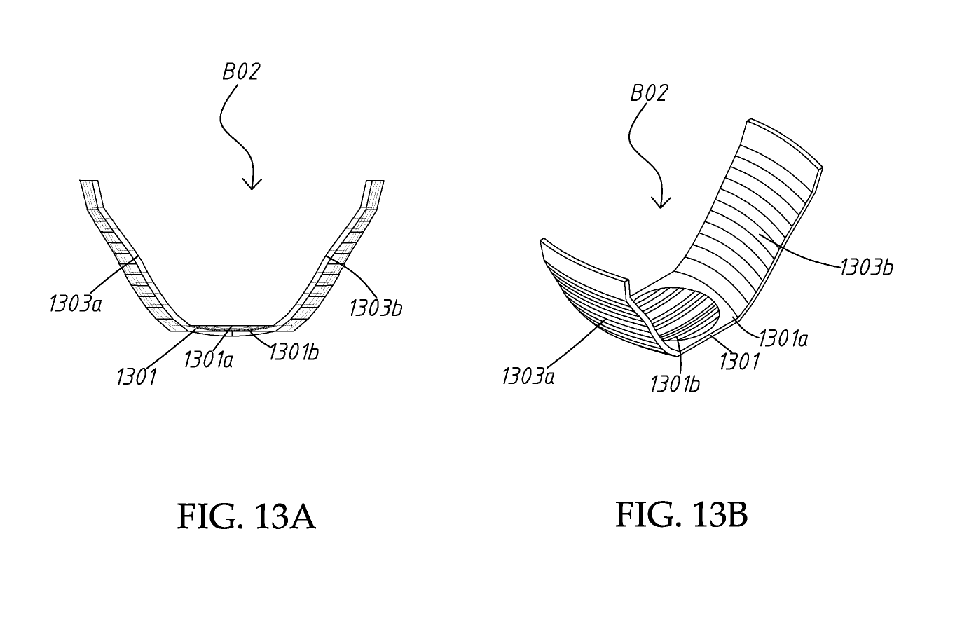

FIGS. 13A and 13b depict the second embodiment of a second reflector of the invention. A second reflector B02 has an inner surface which is a reflecting surface. The second reflector B02 includes a bottom reflecting surface 1301 and two lateral convex reflecting surfaces 1303a and 1303b connected to the bottom surface 1301 to form a U shape. The reflector B02 is integrally formed or assembled by at least two members. The bottom surface 1301 includes a middle curved reflecting surface 1301b and a planar reflecting surface 1301a enclosing the middle curved reflecting surface 1301b. The two lateral convex reflecting surfaces 1303a and 1303b have the same structure as the lateral convex surfaces 1202a and 1202b of the second reflector B01 of FIG. 12. Although the lateral convex surfaces 1303a and 1303b are symmetrical in this embodiment, however the lateral convex reflecting surfaces can be a non-symmetrical in another embodiment.

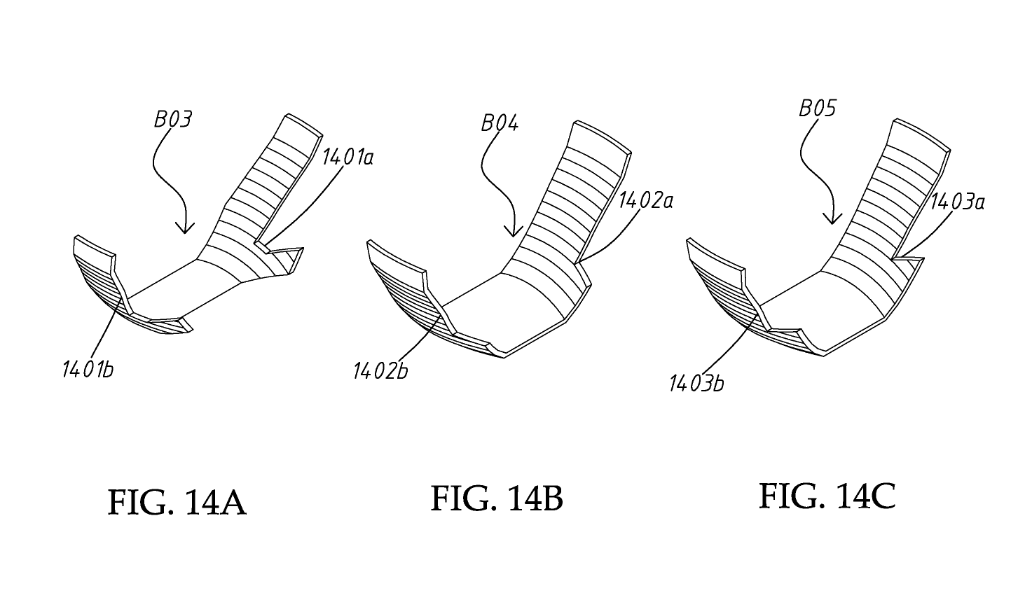

FIGS. 14A to 14C depict the third embodiment to the fifth embodiment of a second reflector of the invention. FIG. 14A shows a second reflector B03 having two lateral convex reflecting surfaces. The lateral convex reflecting surfaces have irregular notches 1401a and 1401b. FIG. 14B shows a second reflector B04 having two lateral convex reflecting surfaces. The lateral convex reflecting surfaces have L-shaped notches 1402a and 1402b. FIG. 14C shows a second reflector B05 having two lateral convex reflecting surfaces. The lateral convex reflecting surfaces have V-shaped notches 1403a and 1403b. The notches allow light from a light source to pass the second reflector and illuminate a predetermined region directly such that various notches form various illuminating region of different widths. Other light from the light source is reflected by the second reflector to reach the predetermined region.

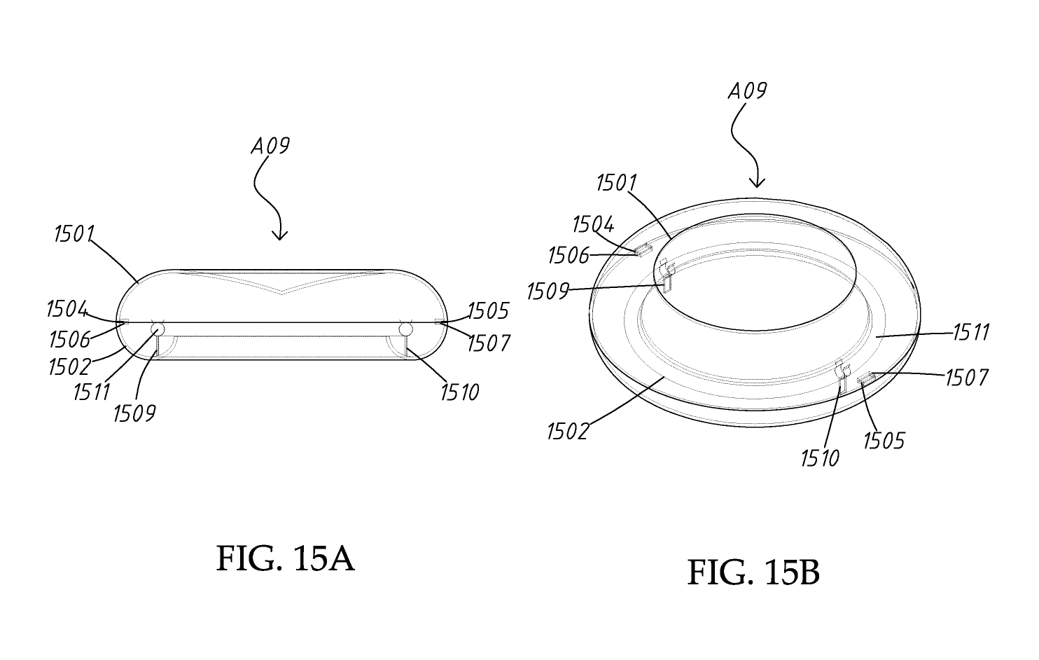

FIGS. 15A and 15B depict the ninth embodiment of a reflecting structure of the invention. The reflecting structure includes a reflector A09. The reflector A09 includes at least two members 1501 and 1502 assembled to form a curved reflector. Each of the members 1501 and 1502 includes a plurality of curved reflecting surfaces connected to each other. Each of the curved reflecting surfaces has an inclined angle different from the inclined angle of other curved reflecting surfaces. The reflector A09 has a J-shaped cross section and has a structure similar to the reflector A01 of FIG. 2A. The reflector A09 has a plurality of curved reflecting surfaces, whereas the reflector A01 has the strip reflecting surfaces. The member 1501 has at least two positioning structures 1504 and 1505 disposed on an inner surface and near an edge thereof, and the member 1502 has at least two positioning structures 1506 and 1507 disposed on an inner surface and near an edge thereof. The positioning structures 1506 and 1507 engage the positioning structures 1501 and 1502 respectively to assemble the members 1502 to 1501. The member 1502 has two clamps 1509 and 1510 to hold a circular tubular light source 1511 or a plurality of LEDs.

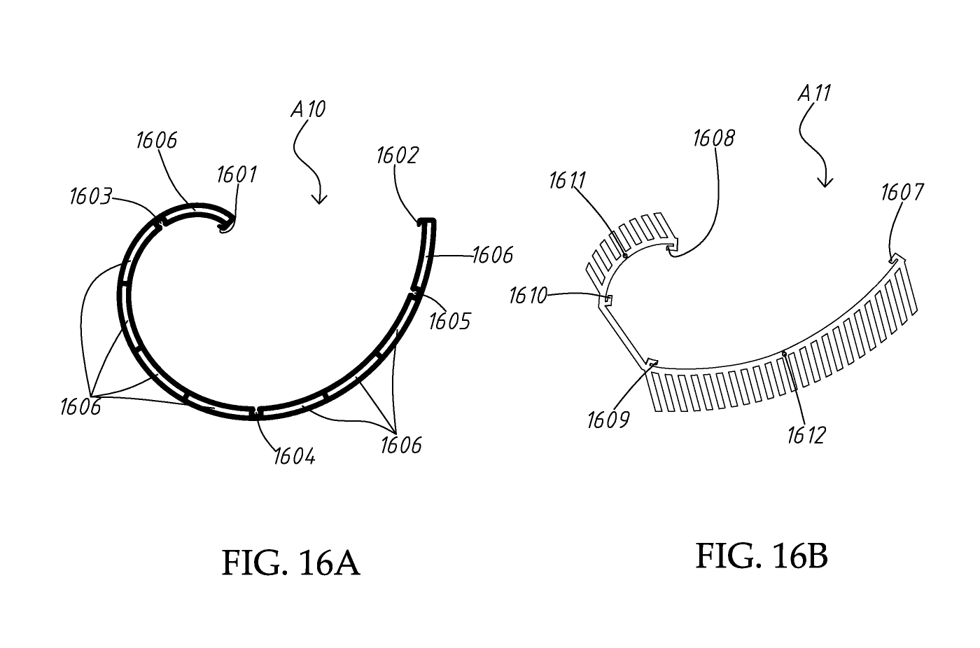

FIGS. 16A and 16B depict the tenth and eleventh embodiments of a reflecting structure of the invention. The reflecting structure includes a reflector A10. The reflector A10 has a larger thickness than the reflector A01, but has an inner surface having the same structure as the reflector A01 of FIG. 2A. A positioning structures 1601 and 1602 which are grooves are formed on a top and a bottom of the reflector A10 for positioning a reflecting material (not shown). Several positioning structures 1603, 1604 and 1605 which are holes are formed on two lateral sides of the reflector A10. The reflector A10 further has a hollow structure 1606 which can save material for manufacturing the reflector A10. A reflector A11 of FIG. 16B is similar to the reflector A05 of FIG. 7. Two positioning structures 1607 and 1608 which are protrusion structure are disposed on a top and a bottom of the reflector A11. Two positioning structures 1609 and 1610 are disposed on an inner surface of the reflector A11. The positioning structures 1607 and 1609 hold reflecting material (not shown), and the positioning structures 1608 and 1610 hold another reflecting material (not shown). Several positioning structures 1611 and 1612 which are holes are disposed on two lateral sides of the reflector A11.

The strip reflecting surface and the curved reflecting surfaces are enlarged for clarity in the figures of the invention, however the strip reflecting surface and the curved reflecting surfaces can be very small so as to form a very smooth reflecting surface of the reflectors when they are applied to a lamp product. Reflecting material can be disposed on the reflecting surface by electrical plating, coating or positioning to increase reflecting efficiency.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reflecting structure for a projecting lamp, comprising:
at least one light source emitting light; and
at least one reflector having an inner surface comprising a plurality of strip reflecting surfaces connected to each other, and each of the strip reflecting surfaces having an inclined angle different from the inclined angles of other strip reflecting surfaces, wherein the reflector has an inward reflecting region and an outward reflecting region, the light source is disposed in the inward reflecting region, and the inward reflecting region locates on an upper portion of the reflector and the outward reflecting surface locates on an lower portion of the reflector; light from the light source is reflected by the inward reflecting region at least once to reach the outward reflecting region and further reflected by the outward reflecting region at least once to reach an object.

2. The reflecting structure as claimed in claim 1, wherein a distance from each of the strip reflecting surfaces to the light source increases gradually from the strip reflecting surface on a bottom of the reflector to the strip reflecting surface on a top of the reflector.

3. The reflecting structure as claimed in claim 1, wherein the reflector comprises a plurality of members, and each of the members has a plurality of strip reflecting surfaces connected to each other, and each of the strip reflecting surfaces having an inclined angle different from the inclined angles of other strip reflecting surfaces.

4. The reflecting structure as claimed in claim 1, wherein the reflector comprises a wide strip reflecting surface having a width larger than the width of the strip reflecting surface, the wide strip reflecting surface is disposed between the outward reflecting region and the inward reflecting region, at least one light emitting diode is disposed on the wide strip reflecting surface, and a plurality of fins is disposed on an outer surface of the reflector.

5. The reflecting structure as claimed in claim 1, wherein the reflector further comprises at least one clamp disposed in an inner space of the reflector.

6. The reflecting structure as claimed in claim 1, wherein the reflector further comprises a second reflecting region comprising at least one strip reflecting surface extending outwards from a bottom of the reflector.

7. The reflecting structure as claimed in claim 1, wherein the strip reflecting surfaces connect to each other to form the reflector of a J-shaped cross section.

8. The reflecting structure as claimed in claim 1, wherein the strip reflecting surfaces connect to each other to form a reflector of a G-shaped cross section.

9. The reflecting structure as claimed in claim 1, wherein the reflector further comprises a plurality of positioning structures protruding from the inner surface.

10. The reflecting structure as claimed in claim 1, wherein the reflector further comprises two end surface, and at least one positioning structure is disposed on each of the end surfaces respectively.

11. The reflecting structure as claimed in claim 1, wherein the reflector has a top and a bottom, each of the strip reflecting surfaces has a length, and the length decreases gradually from the strip reflecting surface on the top to the strip reflecting surface on the bottom.

12. The reflecting structure as claimed in claim 11, wherein the reflector comprises a plurality of members, and each of the members has a plurality of strip reflecting surfaces connected to each other, and each of the strip reflecting surfaces having an inclined angle different from the inclined angles of other strip reflecting surfaces.

13. The reflecting structure as claimed in claim 1 further comprising a second reflector disposed on a bottom of the reflector, wherein the second reflector comprises a bottom reflecting surface and two lateral convex reflecting surfaces connected to the bottom reflecting surface to form a U shape; the bottom reflecting surface is a planar surface, and each of the lateral convex reflecting surfaces comprises a plurality of curved surfaces connected to each other, and each of the curved surfaces has an inclined angle and a curvature different from the inclined angles and the curvatures of other curved surface.

14. The reflecting structure as claimed in claim 13, wherein each of the lateral convex reflecting surfaces has a front end and a notch formed on the front end.

15. The reflecting structure as claimed in claim 13, wherein the second reflector comprises a plurality of members.

16. The reflecting structure as claimed in claim 11, further comprising a second reflector disposed on a bottom of the reflector, wherein the second reflector comprises a bottom reflecting surface and two lateral convex reflecting surfaces connected to the bottom reflecting surface to form a U shape; the bottom reflecting surface comprises a central curved reflecting surface and a planar surface enclosing the central curved reflecting surface, and each of the lateral convex reflecting surfaces comprises a plurality of curved surfaces connected to each other, and each of the curved surfaces has an inclined angle and a curvature different from the inclined angles and the curvatures of other curved surface.

17. The reflecting structure as claimed in claim 16, wherein each of the lateral convex reflecting surfaces has a front end and a notch formed on the front end.

18. The reflecting structure as claimed in claim 16, wherein the second reflector comprises a plurality of members.

19. A reflecting structure comprising:
at least one light source emitting light; and
at least one reflector having an inner surface comprising a plurality of members assembled to form a J-shaped cross section, wherein each of the member comprises a plurality of curved reflecting surfaces connected to each other, each of the curved reflecting surfaces has an inclined angle different from the inclined angles of other curved reflecting surfaces, and a distance from each of the curved reflecting surfaces to the light source increases gradually from the curved reflecting surface on a bottom of the reflector to the curved reflecting surface on a top of the reflector; the reflector has an inward reflecting region and an outward reflecting region, wherein the light source is disposed in the inward reflecting region, and the inward reflecting region locates on an upper portion of the reflector and the outward reflecting surface locates on an lower portion of the reflector; light from the light source is reflected by the inward reflecting region at least once to reach the outward reflecting region and further reflected by the outward reflecting region at least once to reach an object.

20. The reflecting structure as claimed in claim 19, wherein the reflector further comprises a clamp disposed in an inner space of the reflector.
